(19) United States
(12) Patent Application Publication
(10) Pub. No.: US 2023/0260014 A1
(43) Pub. Date: Aug. 17, 2023

(54) DEVICE MANAGEMENT SYSTEM

(71) Applicant: NTT DOCOMO, INC., Chiyoda-ku (JP)

(72) Inventors: Reo MIZUTA, Chiyoda-ku (JP); Kazuoki ICHIKAWA, Chiyoda-ku (JP); Nozomi MATSUMOTO, Chiyoda-ku (JP); Tatsuya NISHIZAKI, Chiyoda-ku (JP)

(73) Assignee: NTT DOCOMO, INC., Chiyoda-ku (JP)

(21) Appl. No.: 18/004,765

(22) PCT Filed: Jun. 11, 2021
(86) PCT No.: PCT/JP2021/022374

§ 371 Date: Jan. 9, 2023

(30) Foreign Application Priority Data
Aug. 5, 2020 (JP) 2020-133023

(51) Int. Cl. G06Q 30/0645; G06F 21/31

(52) U.S. Cl. CPC G06Q 30/0645; G06F 21/31

(57) ABSTRACT

In a device management system 1 including a terminal 20 and a server 10 for managing a device 50 stored in a box 40, the terminal 20 includes: a transmission unit 23 that transmits information associated 5 with the device 50 and user authentication information to the server 10, and the server 10 includes: a unique device code acquisition unit 12 that acquires a unique device code from information associated with the device 50; a lock control unit 13 that instructs the box 40 to unlock; and a login control unit 14 that identifies a user based on the user 10 authentication information and allows the identified user to log in to the device 50 when the box 40 or the device 50 notifies that the device 50 has been taken out with an event indicating that the device 50 has been taken out of the box 40 as a trigger.

### TECHNICAL FIELD

The present disclosure relates to a device management system that executes processing related to rental and return of a rental device stored in a storage (hereinafter referred to as a “box”).

### BACKGROUND ART

Since the past, rental and return services for various rental devices have been known (see Patent Literature 1). In such services, it is desired that the manager side automatically identify both a user and a rental device to be used.

### CITATION LIST

### Patent Literature

[Patent Literature 1] Japanese Unexamined Patent Publication No. 2003-173419

### SUMMARY OF INVENTION

### Technical Problem

Particularly, in recent years, relatively high-priced devices such as notebook computers, tablets, and smartphones have been assumed to be rental devices to be serviced, and it has been expected that both a user and a rental device will be appropriately identified.

On the other hand, from the viewpoint of a user, when a rental process including user identification (user authentication) is performed and then the use of a rental device is started, it has been necessary to perform user authentication such as login again. For this reason, the complexity of user authentication has been a problem.

Consequently, an object of the present disclosure is to appropriately identify both a user and a rental device, and to reduce the complexity of user authentication.

### Solution to Problem

According to the present disclosure, there is provided a device management system including: a terminal configured to be operated by a user; and a server configured to manage a rental device stored in a box, wherein the terminal includes: a transmission unit configured to transmit information associated with the rental device and user authentication information obtained through user authentication to the server, and the server includes: an acquisition unit configured to acquire a unique device code unique to the rental device from the information associated with the rental device; a lock control unit configured to instruct the box to unlock; and a login control unit configured to identify a user on the basis of the user authentication information and allow the identified user to log in to the rental device in a case where the box or the rental device notifies that the rental device has been taken out of the box with an event indicating that the rental device has been taken out of the box as a trigger.

In the above device management system, when the transmission unit in the terminal transmits the information associated with the rental device (for example, a box unique code of the box storing the rental device) and the user authentication information obtained through user authentication to the server, the acquisition unit in the server acquires a unique device code unique to the rental device from the information associated with the rental device, and the lock control unit instructs the box to unlock. Thereby, the box is unlocked, and the rental device is taken out of the box. When the box or the rental device notifies the server that the rental device has been taken out of the box with such an event (that is, an event indicating that the rental device has been taken out of the box) as a trigger, the login control unit identifies a user on the basis of the user authentication information and allows the identified user to log in to the rental device. As described above, the rental device is appropriately identified by the unique device code being acquired in the server, and the user is appropriately identified on the basis of the user authentication information from the terminal. Further, when the box notifies the server that the rental device has been taken out of the box, the login control unit allows the identified user to automatically log in to the rental device, and thus it is possible to eliminate the need for user authentication such as logging in again when the use of the rental device is started, and to reduce the complexity of user authentication.

### Advantageous Effects of Invention

According to the present disclosure, it is possible to appropriately identify both a user and a rental device, and to reduce the complexity of user authentication.

### BRIEF DESCRIPTION OF DRAWINGS

FIG. 1 is a diagram illustrating images of rental and return of a rental device stored in a box.

FIG. 2(a) is a schematic diagram illustrating an example of a state in which a rental device is stored in a box, and FIG. 2(b) is a schematic diagram illustrating an example of a state in which the rental device is taken out of the box.

FIG. 3 is a functional block diagram illustrating a configuration of a device management system of a first embodiment.

FIG. 4 is a diagram illustrating an example of data stored in a storage unit within a server.

FIG. 5 is a flow diagram illustrating a rental process in the first embodiment.

FIG. 6 is a flow diagram illustrating a return process in the first embodiment.

FIG. 7 is a functional block diagram illustrating a configuration of a device management system of a second embodiment.

FIG. 8 is a flow diagram illustrating a rental process in the second embodiment.

FIG. 9 is a flow diagram illustrating a return process in the second embodiment.

FIG. 10 is a functional block diagram illustrating a configuration of a device management system of a third embodiment.

FIG. 11 is a flow diagram illustrating a rental process in the third embodiment.

FIG. 12 is a flow diagram illustrating a return process in the third embodiment.

FIG. 13 is a diagram illustrating a hardware configuration example of a server.

### DESCRIPTION OF EMBODIMENTS

Hereinafter, various embodiments according to the present disclosure will be described with reference to the accompanying drawings. Meanwhile, the same or equivalent components are denoted by the same reference numerals and signs in the description of the drawings, and description may not be repeated.

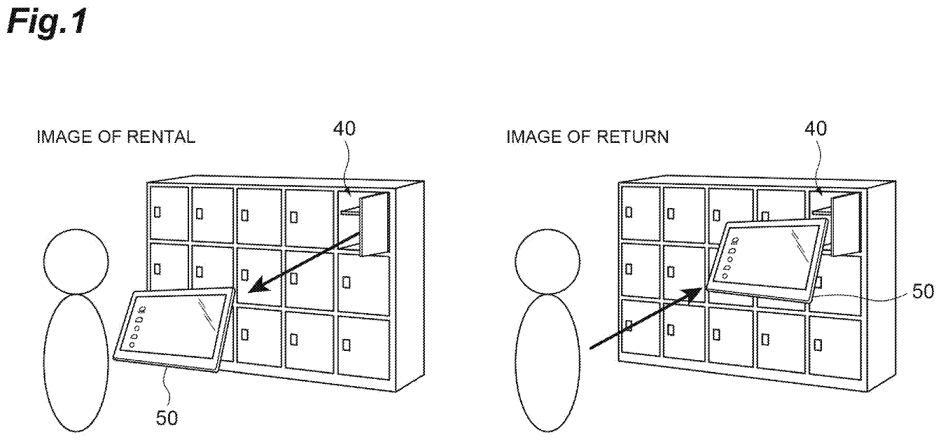

A device management system according to the present disclosure is applied to a service for performing automatic rental and return of a rental device using a machine that performs rental and return. The machine that performs rental and return is assumed to be, for example, a locker-type rental and return machine equipped with a plurality of boxes 40 for storage as shown in FIG. 1, and is assumed to be, in addition to this, a vending machine-type rental and return machine, a box-type rental and return machine constituted by individual boxes, or the like. Among these, an example in which a locker-type rental and return machine is used will be described below.

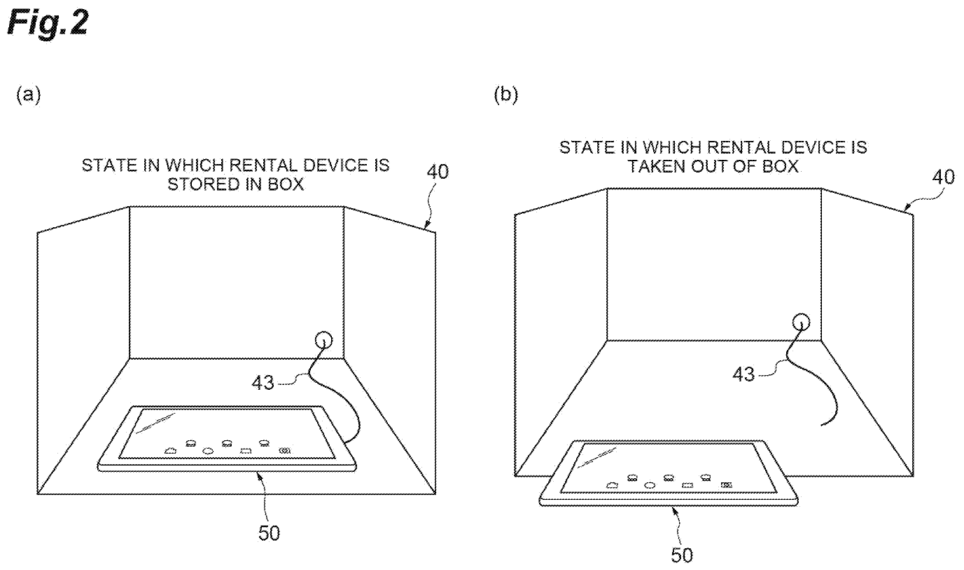

FIG. 2(a) shows a state in which a rental device 50 is stored in a box 40, and the rental device 50 is connected to a cable 43 installed in the box 40. This cable 43 is constituted by, for example, a charging and communication cable for charging the connected rental device 50 and transmitting and receiving information between the rental device 50 and the box 40. Therefore, the rental device 50 is configured to be charged through the cable 43 while waiting in the box 40 before being rented, be in a fully charged state at the time of rental, and be able to transmit and receive information such as a unique device code of the rental device and a box unique code, which will be described later, between the rental device 50 and the box 40. However, it is not essential that the cable 43 be constituted by a charging and communication cable, and the cable 43 may be constituted by a simple cable which is not a charging and communication cable by providing the box 40 with a wireless charging function, a wireless communication function, or the like.

At the time of rental, the box 40 is unlocked by a user's predetermined operation, and the user disconnects the cable 43 from the rental device 50 as shown in FIG. 2(b), takes the rental device 50 out of the box 40 as shown in FIG. 1, and closes the box 40. In addition, at the time of return, the box 40 is unlocked by the user's predetermined operation, and the user puts the rental device 50 into the box 40 as shown in FIG. 1, connects it to the cable 43 so that the rental device is in a storage state shown in FIG. 2(a), and closes the box 40.

Meanwhile, the rental device 50 is assumed to be a device that requires user authentication such as login when the user starts using the device after renting it, such as a notebook personal computer, a tablet, or a smartphone. Although the details will be described later, the present disclosure has the effect of unifying an authentication process at the time of rental and an authentication process at the start of use.

Hereinafter, various embodiments according to the present disclosure will be described in order. A first embodiment to be described below is an embodiment in which the box notifies a server that the rental device has been taken out of the box at the time of rental, and the box notifies the server of a unique device code and a box unique code at the time of return. A second embodiment is an embodiment in which the above notification at the time of rental and return is performed by the rental device instead of the box. A third embodiment is an embodiment in which a beacon that can be detected only within the box is used to detect the rental device being taken out of the box and returned to the box instead of connecting/disconnecting a cable to/from the rental device.

### First Embodiment

The first embodiment is an embodiment in which the box notifies the server that the rental device has been taken out of the box at the time of rental, and the box notifies the server of a unique device code and a box unique code at the time of return.

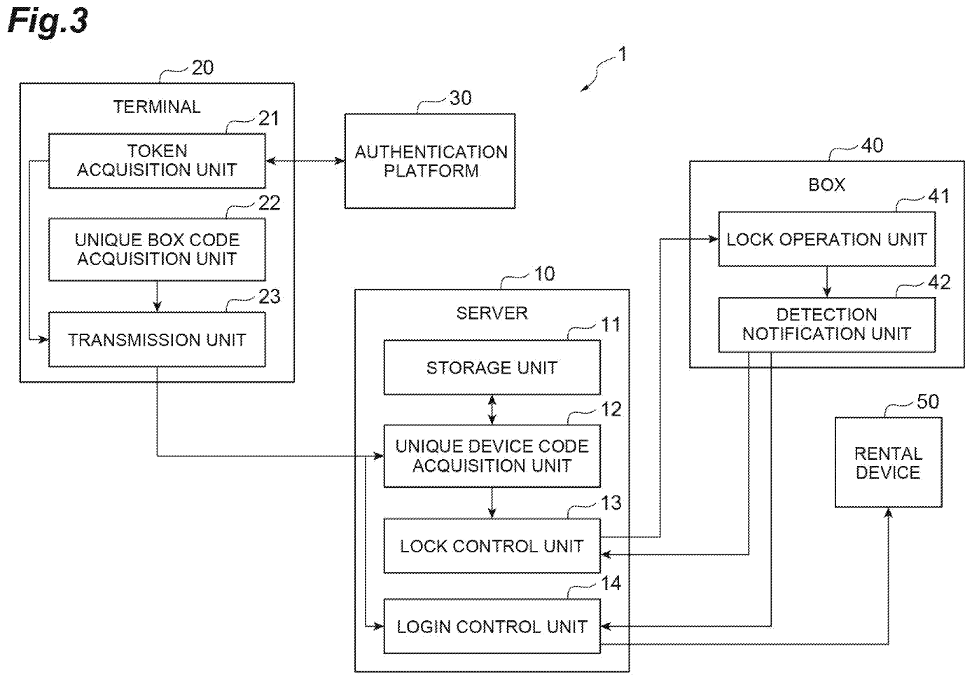

As shown in FIG. 3, a device management system 1 according to the first embodiment includes a terminal 20 which is operated by a user, an authentication platform 30 that performs user authentication in response to a request, the rental device 50, the box 40 that stores the rental device 50, and a server 10 that performs management related to rental and return, lock control of the box 40, and the like. Among these components, the box 40 is provided in advance with a QR code (registered trademark) (not shown) or an NFC tag (not shown) in which a box unique code is recorded.

The authentication platform 30 is a server that performs user authentication in a case where a request for user authentication from the terminal 20 is received, and issues a token related to the user as user authentication information to respond to the terminal 20 with the token in a case where the authentication is successful.

The terminal 20 includes a token acquisition unit 21, a box unique code acquisition unit 22, and a transmission unit 23. The token acquisition unit 21 is a functional unit that requests user authentication from the authentication platform 30 with a predetermined user operation at the time of rental as a trigger, and receives a token issued by the authentication platform 30 in response to the request. The box unique code acquisition unit 22 is a functional unit that acquires information associated with the rental device 50 by reading the QR code or NFC tag of the box 40 in which the rental device 50 to be rented is stored through a user operation at the time of rental (here, the box unique code of the box 40 in which the rental device 50 is stored). The transmission unit 23 is a functional unit that receives a token from the token acquisition unit 21 and a box unique code from the box unique code acquisition unit 22, and transmits the token and the box unique code to the server 10.

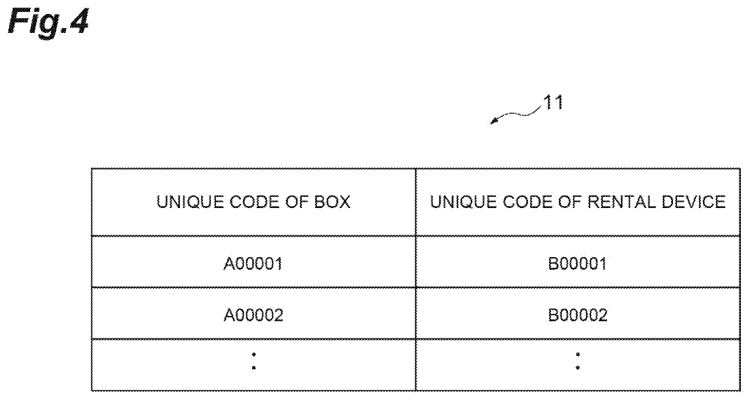

The server 10 includes a storage unit 11, a unique device code acquisition unit 12, a lock control unit 13, and a login control unit 14. Among these components, the storage unit 11 is a functional unit that stores a box unique code and a unique device code associated with the box unique code as shown in FIG. 4. For information on association of the box unique code with the unique device code shown in FIG. 4, for example, the server 10 acquires the box unique code of the box 40 and the unique device code of the rental device 50 stored in the box 40, in advance, from the box 40 through the cable 43, and stores these codes in the storage unit 11. The unique device code acquisition unit 12 is a functional unit that refers to the storage unit 11 to acquire the unique device code associated with the box unique code transmitted from the terminal 20 at the time of rental. The unique device code acquisition unit 12 acquires the box unique code and the unique device code from the box 40 at the time of return. The lock control unit 13 is a functional unit that instructs the box 40 to lock or unlock. In a case where it is notified that the rental device 50 has been taken out of the box 40 at the time of rental, the login control unit 14 is a functional unit that identifies a user on the basis of a token transmitted from the terminal 20 and allows the identified user to automatically log in to the rental device 50. The login control unit 14 automatically logs out the rental device 50 corresponding to the unique device code acquired by the unique device code acquisition unit 12 at the time of return.

The box 40 in the first embodiment includes a lock operation unit 41 and a detection notification unit 42. The lock operation unit 41 out of the two is a functional unit that performs locking or unlocking on the basis of an instruction from the lock control unit 13 of the server 10. The detection notification unit 42 is a functional unit that detects that the cable 43 in the box 40 has been disconnected from the rental device 50 at the time of rental using an existing method and notifies the server 10 that the rental device 50 has been taken out of the box 40. The detection notification unit 42 detects that the rental device 50 is connected to the cable 43 within the box 40 at the time of return using an existing method, acquires the unique device code from the rental device 50 through the cable 43, and notifies the server 10 of the box unique code, the unique device code, and the closing of the box.

### Processing at Time of Rental in First Embodiment

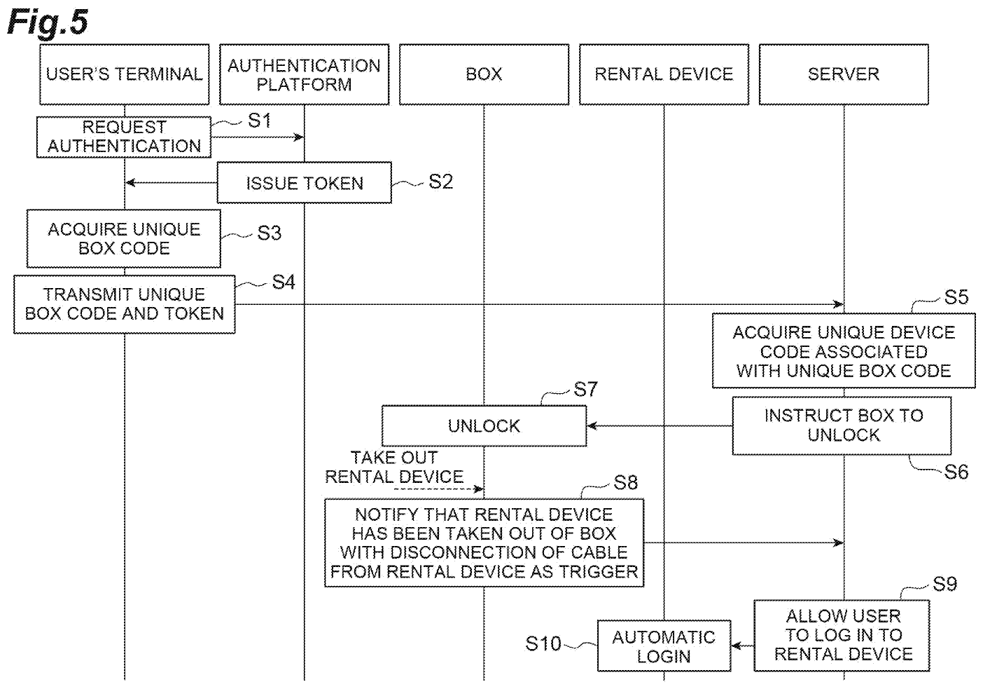

As shown in FIG. 5, when the token acquisition unit 21 of the terminal 20 requests user authentication from the authentication platform 30 (step S1), the authentication platform 30 performs user authentication, issues a token, and responds to the token acquisition unit 21 (step S2). In addition, the box unique code acquisition unit 22 of the terminal 20 reads the QR code or NFC tag of the box 40 in which the rental device 50 to be rented is stored by a user's operation at the time of rental to thereby acquire the box unique code of the box 40 (step S3). The transmission unit 23 receives the token from the token acquisition unit 21 and the box unique code from the box unique code acquisition unit 22, and transmits the token and the box unique code to the server 10 (step S4).

In the server 10, the unique device code acquisition unit 12 refers to the storage unit 11 to acquire the unique device code associated with the box unique code transmitted from the terminal 20 (step S5), and the lock control unit 13 instructs the box 40 to unlock (step S6). In the box 40 that has received this instruction, the lock operation unit 41 performs unlocking (step S7).

When the box 40 is unlocked and a user disconnects the cable 43 within the box 40 from the rental device 50 and takes the rental device 50 out of the box 40 as shown in FIG. 2(b), the detection notification unit 42 of the box 40 detects that the cable 43 has been disconnected from the rental device 50 and notifies the server 10 that the rental device 50 has been taken out of the box 40 (step S8). When this notification is received, the login control unit 14 identifies a user on the basis of the token transmitted from the terminal 20, and sends a control signal to allow the identified user to automatically log in to the rental device 50 (step S9). Thereby, automatic login of the user based on the control signal is executed in the rental device 50 (step S10). Meanwhile, information on the user identified in step S9 is associated with the unique device code, stored by the login control unit 14, and used in processing at the time of return which will be described later. With the above, the processing at the time of rental in FIG. 5 ends.

Through the processing of FIG. 5, both the user and the rental device can be appropriately identified in the server. In addition, when the box notifies that the rental device has been taken out of the box, the login control unit allows the identified user to automatically log in to the rental device, and thus it is possible to eliminate the need for user authentication such as logging in again when the use of the rental device is started, and to reduce the complexity of user authentication.

### Processing at Time of Return in First Embodiment

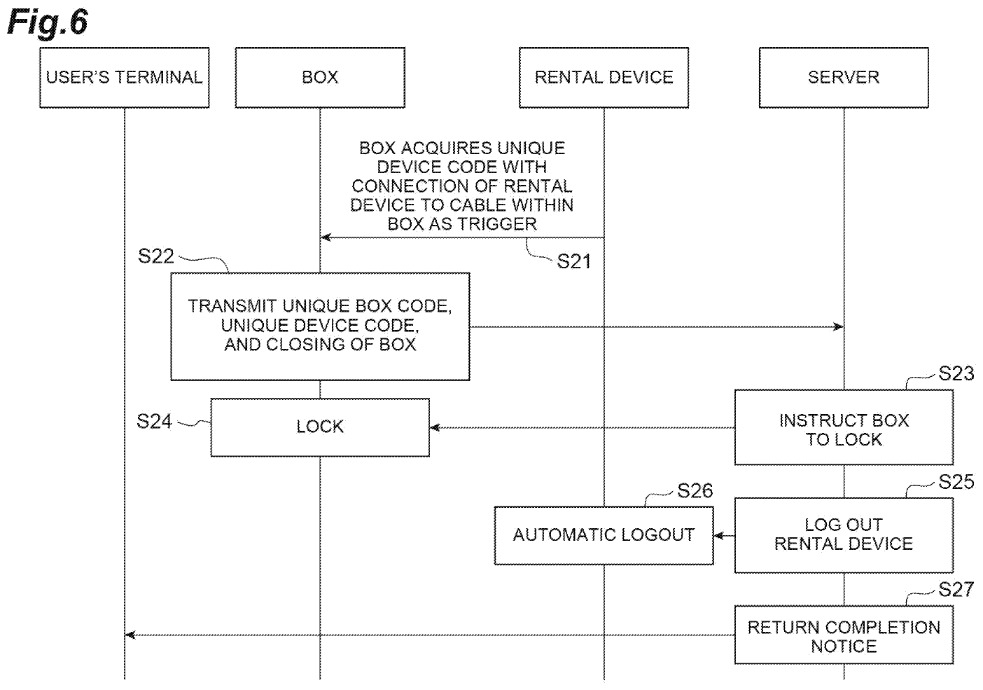

A user opens the box 40 through a predetermined operation, connects the rental device 50 to the cable 43 within the box 40 to store it in the box 40, and closes the box 40. In this case, the detection notification unit 42 of the box 40 detects that the rental device 50 is connected to the cable 43, and uses this as a trigger to acquire the unique device code from the rental device 50 through the cable 43 (step S21 in FIG. 6).

The detection notification unit 42 then transmits the box unique code of its own device (the box 40), the acquired unique device code, and the closing of the box to the lock control unit 13 and the login control unit 14 of the server 10 (step S22).

In the server 10 that has received the above information, the lock control unit 13 instructs the box 40 to lock (step S23), and in the box 40 that has received this instruction, the lock operation unit 41 performs locking (step S24). In addition, the login control unit 14 identifies a user (a user who has performed rental) associated with the unique device code notified of by the detection notification unit 42 and then sends a control signal to log out the rental device 50 corresponding to the unique device code (step S25), and the rental device 50 automatically logs the user out on the basis of the control signal (step S26). Further, the login control unit 14 transmits a return completion notice to the terminal 20 (step S27), and ends the processing of FIG. 6.

Through the processing of FIG. 6, both the user and the rental device can be appropriately identified in the server. In addition, since the rental device 50 corresponding to the unique device code is automatically logged out, it is possible to eliminate the need for user authentication such as logging out again when the use of the rental device is completed, and to reduce the complexity of user authentication.

### Second Embodiment

The second embodiment is an embodiment in which the rental device notifies the server that “the rental device has been taken out of the box” in the processing at the time of rental and notifies the server of the unique device code and the box unique code in the processing at the time of return, instead of the box unlike the first embodiment.

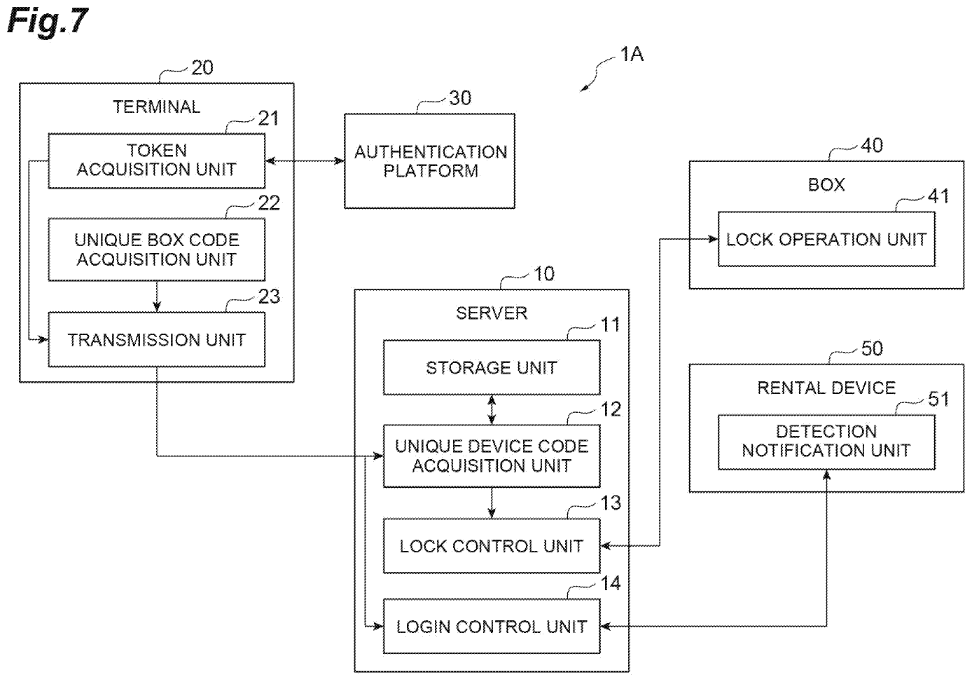

In a device management system 1A shown in FIG. 7, a rental device 50 includes a detection notification unit 51 equivalent to the detection notification unit 42 of the box 40 of first embodiment. The detection notification unit 51 is a functional unit that detects that the cable 43 in the box 40 has been disconnected from the rental device 50 at the time of rental using an existing method and notifies the server 10 that the rental device 50 has been taken out of the box 40. The detection notification unit 51 detects that the rental device 50 is connected to the cable 43 within the box 40 at the time of return using an existing method, acquires the box unique code from the box 40 through the cable 43, and notifies the server 10 of the box unique code and the unique device code.

In addition, as in the first embodiment, the lock operation unit 41 of the box 40 is a functional unit that performs locking or unlocking on the basis of an instruction from the lock control unit 13 of the server 10, and notifies the server 10 that box is closed at the time of return.

### Processing at Time of Rental in Second Embodiment

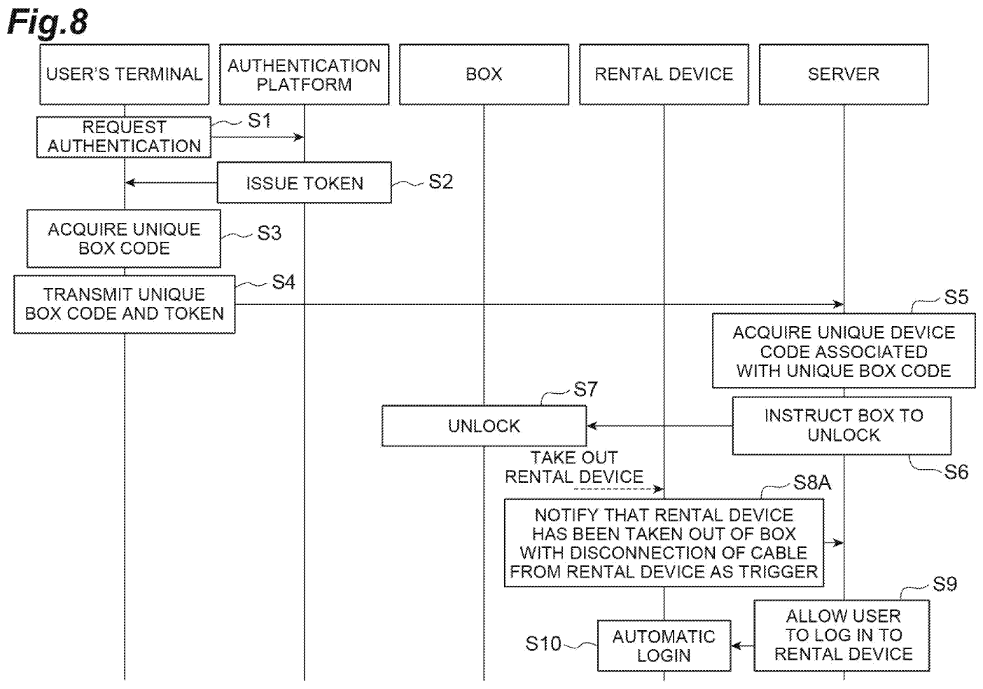

FIG. 8 shows processing at the time of rental in the second embodiment. Steps S1 to S7 are the same as the processing at the time of rental in the first embodiment (FIG. 5), and thus description thereof will not be repeated.

When the box 40 is unlocked in step S7 of FIG. 8, and then a user disconnects the cable 43 from the rental device 50 and takes the rental device 50 out of the box 40 as shown in FIG. 2(b), the detection notification unit 51 of the rental device 50 detects that the cable 43 has been disconnected from the rental device 50 and notifies the server 10 that the rental device 50 has been taken out of the box 40 (step S8A). When this notification is received, the login control unit 14 of the server 10 identifies a user on the basis of the token transmitted from the terminal 20 in step S4, and allows the identified user to automatically log in to the rental device 50 (step S9). Here, for example, the login control unit 14 sends a control signal including an automatic login command to the rental device 50, whereby automatic login of the user based on the control signal is executed in the rental device 50 (step S10).

In the above processing of FIG. 8, both the user and the rental device can also be appropriately identified in the server. In addition, when the box notifies that the rental device has been taken out of the box, the identified user is allowed to automatically log in to the rental device, and thus it is possible to eliminate the need for user authentication such as logging in again when the use of the rental device is started, and to reduce the complexity of user authentication.

### Processing at Time of Return in Second Embodiment

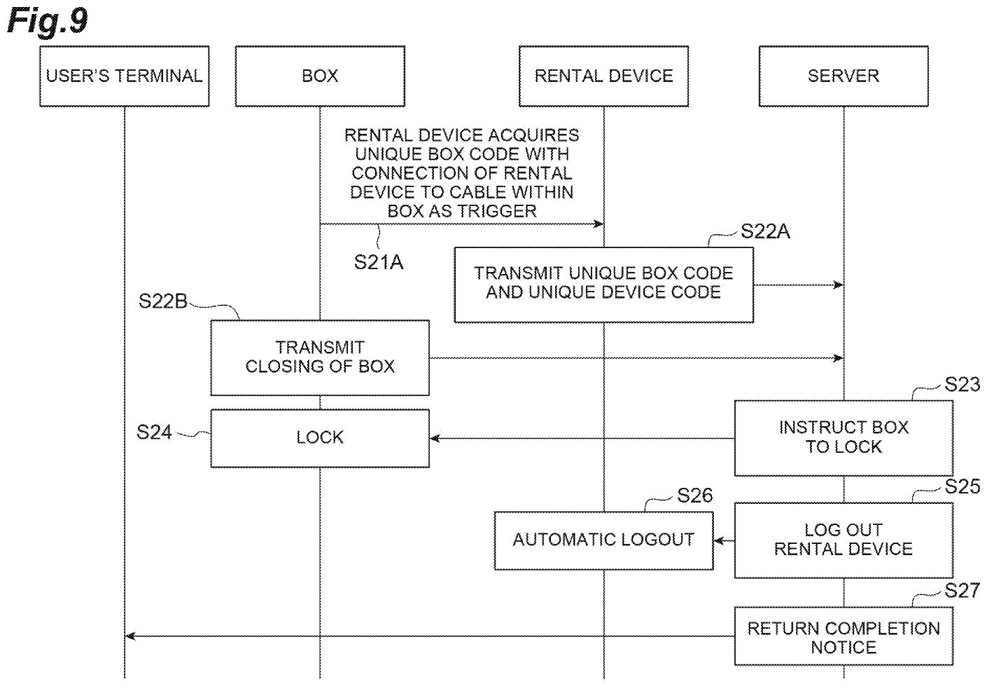

FIG. 9 shows processing at the time of return in the second embodiment. The user opens the box 40 through a predetermined operation, connects the rental device 50 to the cable 43 within the box 40 to store it in the box 40, and closes the box 40. In this case, the detection notification unit 51 of the rental device 50 detects that the rental device 50 is connected to the cable 43, and uses this as a trigger to acquire the box unique code from the box 40 through the cable 43 (step S21A).

The detection notification unit 51 transmits the unique code of the box and the unique code of the rental device to the lock control unit 13 and the login control unit 14 of the server 10 (step S22A), and the lock operation unit 41 of the box 40 notifies the server 10 that the box 40 is closed (step S22B).

After that, as in the first embodiment (FIG. 6), locking based on a lock instruction from the lock control unit 13 of the server 10 (steps S23 and S24), automatic logout based on a logout control signal from the login control unit 14 (steps S25 and S26), and a return completion notice to the terminal 20 (step S27) are executed.

In the processing of FIG. 9, both the user and the rental device can also be appropriately identified in the server. In addition, by automatically logging out the rental device 50 corresponding to the unique device code, it is possible to eliminate the need for user authentication such as logging out again when the use of the rental device is completed, and to reduce the complexity of user authentication.

### Third Embodiment

The third embodiment is an embodiment in which the rental device notifies the server that “the rental device has been taken out of the box” in the processing at the time of rental and notifies the server of the unique device code and the box unique code in the processing at the time of return as in the second embodiment. However, the third embodiment is different from the first and second embodiments in that, instead of the cable used when the rental device is stored in the box in the first and second embodiments, a beacon that can be detected only within the box is used to detect the rental device being taken out of the box and returned to the box.

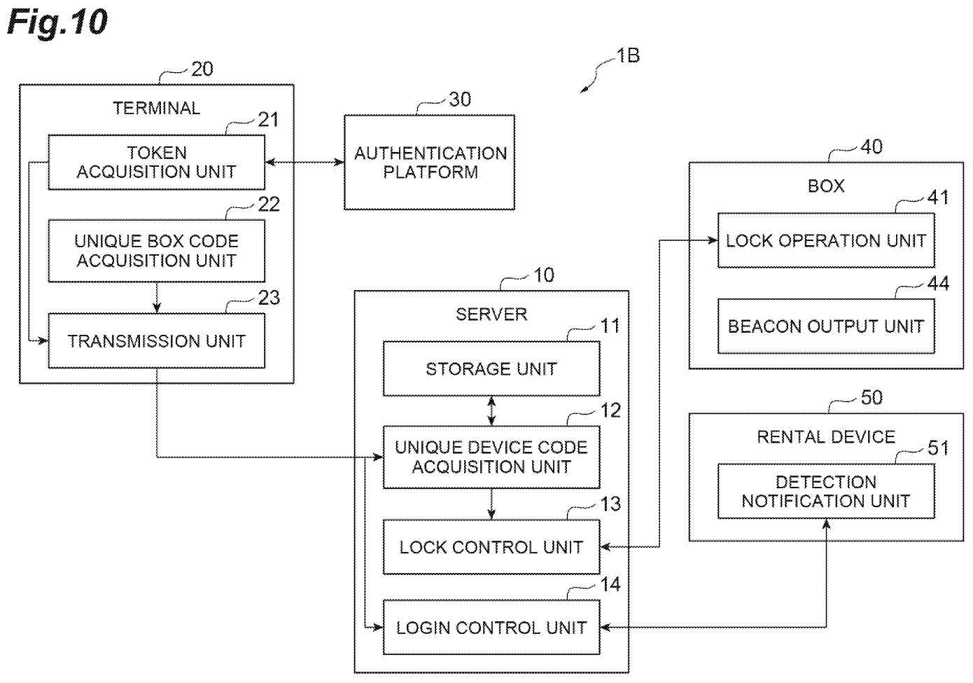

In a device management system 1B shown in FIG. 10, the box 40 further includes a beacon output unit 44 that outputs a beacon, and the beacon which is output from the beacon output unit 44 has its output level adjusted in advance so that it can be detected by the rental device 50 only within the box 40. Therefore, the detection notification unit 51 of the rental device 50 determines that the rental device 50 has been taken out of the box 40 in a case where a previously detected beacon is no longer detected, and determines that the rental device 50 has been returned to the box 40 in a case where a previously undetected beacon is detected. In a case where it is determined that the rental device 50 has been returned to the box 40, the detection notification unit 51 has a function of acquiring a box unique code from the box 40 through near field communication such as, for example, Bluetooth (registered trademark). Meanwhile, the rental device 50 need only be charged by, for example, a wireless charging facility provided in the box 40.

### Processing at Time of Rental in Third Embodiment

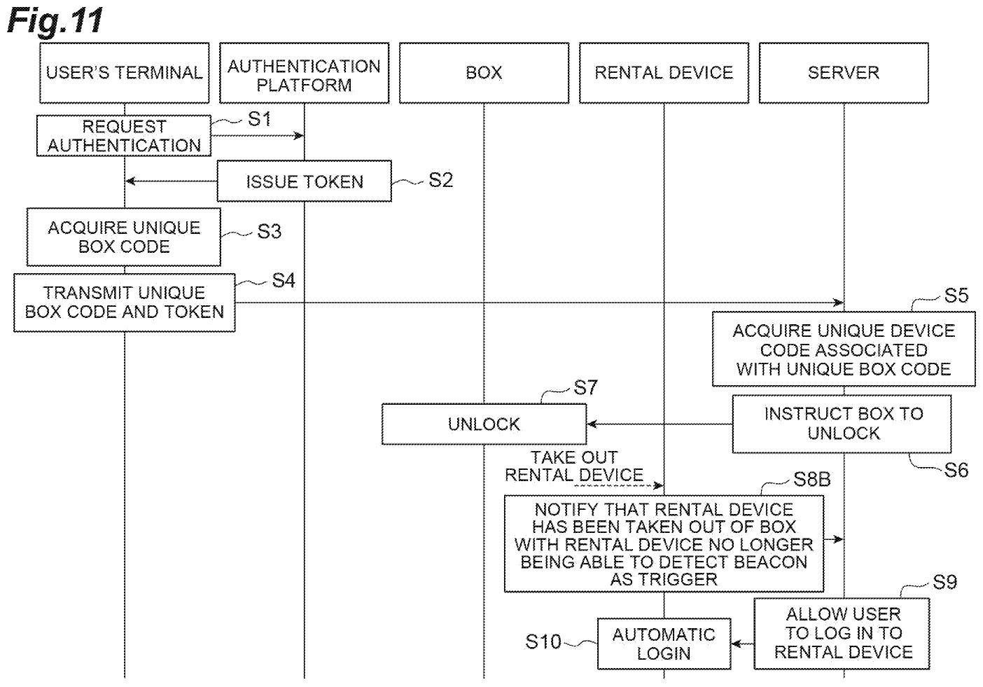

FIG. 11 shows processing at the time of rental in the third embodiment. Steps 51 to S7 are the same as the processing at the time of rental in the first and second embodiments, and thus description thereof will not be repeated.

When the box 40 is unlocked in step S7 of FIG. 11, and then the user opens the box 40 and takes the rental device 50 out of the box 40, the previously detected beacon is no longer detected, and thus the detection notification unit 51 of the rental device 50 uses this event as a trigger to notify the server 10 that the rental device 50 has been taken out of the box 40 (step S8B). When this notification is received, the login control unit 14 of the server 10 identifies the user on the basis of the token transmitted from the terminal 20 in step S4, and allows the identified user to automatically log in to the rental device 50 (step S9). Here, for example, the login control unit 14 sends a control signal including an automatic login command to the rental device 50, whereby automatic login of the user based on the control signal is executed in the rental device 50 (step S10).

In the above processing of FIG. 11, both the user and the rental device can also be appropriately identified in the server. In addition, when the box notifies that the rental device has been taken out of the box with beacon non-detection as a trigger, the identified user is allowed to automatically log in to the rental device, and thus it is possible to eliminate the need for user authentication such as logging in again when the use of the rental device is started, and to reduce the complexity of user authentication.

### Processing at Time of Return in Third Embodiment

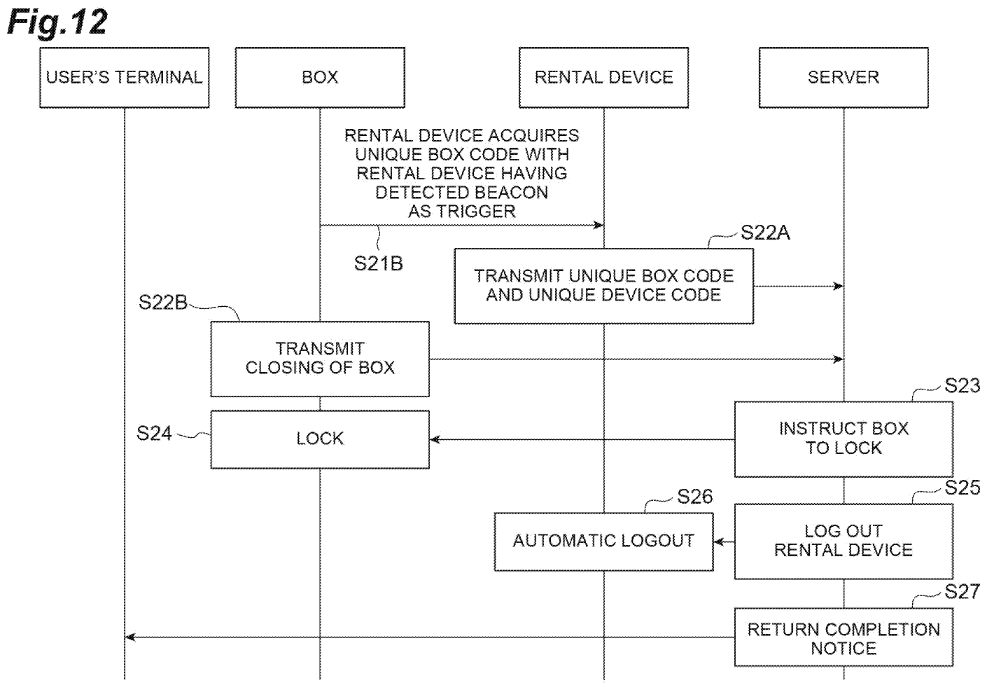

FIG. 12 shows processing at the time of return in the third embodiment. The user opens the box 40 through a predetermined operation, stores the rental device 50 in the box 40, and closes the box 40. In this case, since a previously undetected beacon is detected, the detection notification unit 51 of the rental device 50 uses this event as a trigger to acquire the box unique code from the box 40 (step S21B). The acquisition method here is not limited to a specific method, and the detection notification unit 51 may acquire the box unique code from the box 40 through near field communication, such as, for example, Bluetooth (registered trademark).

The detection notification unit 51 transmits the unique code of the box and the unique code of the rental device to the lock control unit 13 and the login control unit 14 of the server 10 (step S22A), and the lock operation unit 41 of the box 40 notifies the server 10 that the box 40 is closed (step S22B). After that, as in the first and second embodiments, locking based on a lock instruction from the lock control unit 13 of the server 10 (steps S23 and S24), automatic logout based on a logout control signal from the login control unit 14 (steps S25 and S26), and a return completion notice to the terminal 20 (step S27) are executed.

In the above processing of FIG. 12, both the user and the rental device can also be appropriately identified in the server. In addition, by automatically logging out the rental device 50 corresponding to the unique device code, it is possible to eliminate the need for user authentication such as logging out again when the use of the rental device is completed, and to reduce the complexity of user authentication.

Meanwhile, although an example in which a beacon that can be detected only within the box has been described in the third embodiment, signals, sound waves, electric waves, electromagnetic waves, and the like that can be detected only within the box may be used in addition to the above beacon.

In addition, an example in which the notification of “the box is closed” is transmitted from the box 40 to the server 10 has been described in the return processing (FIGS. 9 and 12) in the second and third embodiments, but instead, the above notification may be transmitted from the box 40 to the rental device 50 and transmitted from the rental device 50 to the server 10 together with the box unique code and the unique device code.

### Terms, Modifications, and the Like

Meanwhile, the block diagram used in the description of the above embodiment represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. In either case, as described above, realization methods are not particularly limited.

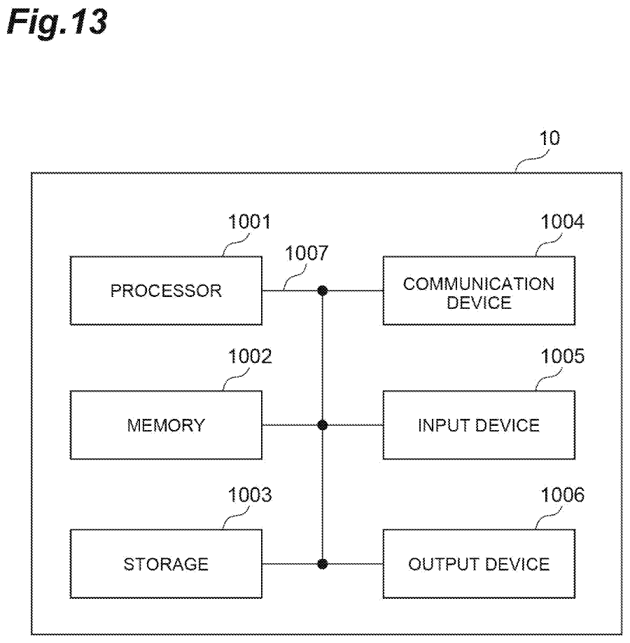

For example, each device (such as, for example, the server 10) that constitutes the device management system may function as a computer that performs the processing in the present embodiment. FIG. 13 is a diagram illustrating a hardware configuration example of the server 10. The above-described server 10 may be physically configured as a computer device including a processor 1001, a memory 1002, a storage 1003, a communication device 1004, an input device 1005, an output device 1006, a bus 1007, and the like. The same applies to each device other than the server 10 that constitutes the device management system.

Meanwhile, in the following description, the word “device” may be replaced with “circuit,” “unit,” or the like. The hardware configuration of the server 10 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the server 10 is realized by controlling communication in the communication device 1004 or controlling at least one of reading-out and writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like.

In addition, the processor 1001 reads out a program (a program code), a software module, data, or the like from at least one of the storage 1003 and the communication device 1004 into the memory 1002, and executes various types of processes in accordance therewith. An example of the program which is used includes a program causing a computer to execute at least some of the operations described in the foregoing embodiment. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (a program code), a software module, or the like that can be executed in order to carry out a wireless communication method according to an embodiment of the present disclosure.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including at least one of the memory 1002 and the storage 1003, a server, or another suitable medium.

The communication device 1004 is hardware (a transmitting and receiving device) for performing communication between computers through at least one of a wired network and a wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel). In addition, respective devices such as the processor 1001 and the memory 1002 are connected to each other through the bus 1007 for communicating information. The bus 1007 may be configured using a single bus, or may be configured using different buses between devices.

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims. Therefore, the description of the present disclosure is intended for illustrative explanation only, and does not impose any limited interpretation on the present disclosure.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

The input or output information or the like may be stored in a specific place (for example, a memory) or may be managed using a management table. The input or output information or the like may be overwritten, updated, or added. The output information or the like may be deleted. The input information or the like may be transmitted to another device.

An expression “on the basis of” which is used in the present disclosure does not refer to only “on the basis of only,” unless otherwise described. In other words, the expression “on the basis of” refers to both “on the basis of only” and “on the basis of at least.”

In the present disclosure, when the terms “include,” “including,” and modifications thereof are used, these terms are intended to have a comprehensive meaning similarly to the term “comprising.” Further, the term “or” which is used in the present disclosure is intended not to mean an exclusive logical sum.

In the present disclosure, when articles are added by translation like, for example, “a,” “an” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

### REFERENCE SIGNS LIST

1, 1A, 1B: Device management system; 10: Server; 11: Storage unit; 12: Device unique code acquisition unit; 13: Lock control unit; 14: Login control unit; 20: Terminal; 21: Token acquisition unit; 22: Box unique code acquisition unit; 23: Transmission unit; 30: Authentication platform; 40: Box; 41: Lock operation unit; 42: Detection notification unit; 43: Cable; 44: Beacon output unit; 50: Rental device; 51: Detection notification unit; 1001: Processor; 1002: Memory; 1003: Storage; 1004: Communication device; 1005: Input device; 1006: Output device; 1007: Bus.

1. A device management system comprising:
a terminal configured to be operated by a user; and
a server configured to manage a rental device stored in a box,
wherein the terminal includes: a transmission unit configured to transmit information associated with the rental device and user authentication information obtained through user authentication to the server, and
the server includes:
an acquisition unit configured to acquire a unique device code unique to the rental device from the information associated with the rental device;
a lock control unit configured to instruct the box to unlock; and
a login control unit configured to identify a user on the basis of the user authentication information and allow the identified user to log in to the rental device in a case where the box or the rental device notifies that the rental device has been taken out of the box with an event indicating that the rental device has been taken out of the box as a trigger.

2. The device management system according to claim 1, wherein the box notifies the server that the rental device has been taken out of the box with disconnection of the rental device from a cable within the box as a trigger.

3. The device management system according to claim 1, wherein the rental device notifies the server that the rental device has been taken out of the box with disconnection of the rental device from a cable within the box as a trigger.

4. The device management system according to claim 1, wherein the rental device notifies the server that the rental device has been taken out of the box with the rental device no longer being able to detect a beacon detectable only within the box as a trigger.

5. The device management system according to claim 1, wherein a box unique code unique to a box that stores the rental device is used as information associated with the rental device,
the server further includes a storage unit that stores the box unique code and a unique device code associated with the box unique code, and
the acquisition unit refers to the storage unit to acquire a unique device code associated with the box unique code transmitted from the terminal.

6. A device management system comprising a server configured to manage a rental device stored in a box,
wherein the server includes:
an acquisition unit configured to acquire information associated with the rental device and a unique device code unique to the rental device from the box or the rental device with an event indicating that the rental device has been returned to the box as a trigger;
a lock control unit configured to instruct the box to lock in a case where it is notified that the box has been closed; and
a login control unit configured to log out a rental device corresponding to the acquired unique device code.

7. The device management system according to claim 6, wherein a box unique code unique to a box that stores the rental device is used as information associated with the rental device, and
in a case where the rental device is connected to a cable within the box, the box acquires the unique device code of the rental device from the rental device and notifies the server of the acquired unique device code and the box unique code.

8. The device management system according to claim 6, wherein a box unique code unique to a box that stores the rental device is used as information associated with the rental device, and
in a case where the rental device is connected to a cable within the box, the rental device acquires the box unique code from the box and notifies the server of the acquired box unique code and its own unique device code.

9. The device management system according to claim 6, wherein a box unique code unique to a box that stores the rental device is used as information associated with the rental device, and
in a case where the rental device detects a beacon detectable only within the box, the rental device acquires the box unique code from the box and notifies the server of the acquired box unique code and its own unique device code.

10. The device management system according to claim 2, wherein a box unique code unique to a box that stores the rental device is used as information associated with the rental device,
the server further includes a storage unit that stores the box unique code and a unique device code associated with the box unique code, and
the acquisition unit refers to the storage unit to acquire a unique device code associated with the box unique code transmitted from the terminal.

11. The device management system according to claim 3, wherein a box unique code unique to a box that stores the rental device is used as information associated with the rental device,
the server further includes a storage unit that stores the box unique code and a unique device code associated with the box unique code, and
the acquisition unit refers to the storage unit to acquire a unique device code associated with the box unique code transmitted from the terminal.

12. The device management system according to claim 4, wherein a box unique code unique to a box that stores the rental device is used as information associated with the rental device,
the server further includes a storage unit that stores the box unique code and a unique device code associated with the box unique code, and
the acquisition unit refers to the storage unit to acquire a unique device code associated with the box unique code transmitted from the terminal.
